(19) United States
(12) Patent Application Publication
(10) Pub. No.: US 2014/0362211 A1
(43) Pub. Date: Dec. 11, 2014

(54) MOBILE TERMINAL DEVICE, DISPLAY CONTROL METHOD, AND COMPUTER PROGRAM PRODUCT

(71) Applicants: KABUSHIKI KAISHA TOSHIBA, Tokyo (JP); TOSHIBA LIFESTYLE PRODUCTS & SERVICES CORPORATION, Tokyo (JP)

(72) Inventors: Kazuyasu OHWAKI, Ome Tokyo (JP); Masaki TSUCHIDA, Hamura Tokyo (JP); Toshio OBAYASHI, Ome Tokyo (JP)

(21) Appl. No.: 14/465,678

(22) Filed: Aug. 21, 2014

Related U.S. Application Data
(63) Continuation of application No. PCT/JP2013/059358, filed on Mar. 28, 2013.

(51) Int. Cl. G01B 11/02; G06T 1/00

(52) U.S. Cl. CPC G01B 11/022; G06T 1/00
USPC 348/135

(57) ABSTRACT

According to one embodiment, a mobile terminal includes module, display, receiver, and transmitter. The module acquires image of at least portion of screen of display device. When image contains side of the screen, the transmitter calculates distance from the screen to the mobile terminal by using the size of the screen, angle of view of the module, and ratio between length of side of the screen contained in the image and length of side of the image. When the image contains test chart, the transmitter receives number of pixels of the test chart, resolution of the screen, and angle of view of the module, calculates the distance by using the number of pixels, the resolution, the angle of view, and a ratio between size of the test chart contained in the image and size of the image.

### CROSS-REFERENCE TO RELATED APPLICATIONS

This application is a continuation of international application No. PCT/JP2013/059358, filed Mar. 28, 2013, which designates the United States, the entire contents of which are incorporated herein by reference.

### FIELD

Embodiments described herein relate generally to a mobile terminal device, a display control method, and a computer program product.

### BACKGROUND

There has been disclosed a technique for detecting a viewer position (for example, a distance from a display device to a viewer) that is the position of a viewer who is watching a display device such as a television, and optimizing image quality parameters for an image displayed on the display device, and parameters (such as depth information) that is used when a stereoscopic image is displayed on the display device, depending on the detected viewer position. As a method for detecting the viewer position, there have been disclosed several methods such as, for example: a method using a distance sensor such as an infrared sensor to detect the viewer position; and a method using a camera provided in a display device to acquire the face of a viewer to obtain a distance between the eyes of the viewer's face in an image acquired by the camera to detect the viewer position.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an external perspective view illustrating one example of a television broadcast display device according to a first embodiment;

FIG. 2 is a diagram illustrating an example of a hardware configuration of a mobile terminal device according to the first embodiment;

FIG. 3 is a block diagram illustrating a functional configuration of the mobile terminal device according to the first embodiment;

FIG. 4 is a flowchart illustrating a processing for calculating a viewing distance by the mobile terminal device according to the first embodiment;

FIG. 5 is a diagram for explaining the processing for calculating the viewing distance by the mobile terminal device according to the first embodiment;

FIG. 6 is a block diagram illustrating a functional configuration of the mobile terminal device according to a second embodiment;

FIG. 7 is a flowchart illustrating a processing for transmitting adjustment information by the mobile terminal device according to the second embodiment;

FIG. 8 is a diagram illustrating one example of an acquired image obtained by acquiring a display screen displaying a test chart according to the second embodiment;

FIG. 9 is a block diagram illustrating a functional configuration of a mobile terminal device according to a third embodiment;

FIG. 10 is a flowchart illustrating a processing for transmitting the adjustment information by the mobile terminal device according to the third embodiment; and

FIG. 11 is a diagram for explaining the processing for acquiring the viewing position by a mobile terminal device according to a modification.

### DETAILED DESCRIPTION

In general, according to one embodiment, a mobile terminal device comprises an image acquiring module, a display, a receiver, and a transmitter. The image acquiring module is capable of acquiring an image of at least a portion of a display screen of a display device. The display is capable of displaying an acquired image acquired by the image acquiring module. The receiver receives, from the display device, specifying information that is capable of specifying a size of the display screen. When the acquired image contains a side of the display screen, the transmitter calculates a distance from the display screen to the mobile terminal device by using the size of the display screen specified by the received specifying information, an angle of view of the image acquiring module, and a ratio between a length of a side of the display screen contained in the acquired image and a length of a side of the acquired image, and transmits the distance to the display device as an adjustment information for causing the display device to adjust image quality of the display screen. When the acquired image contains a test chart displayed on the display screen, the transmitter receives a number of pixels of the test chart, resolution of the display screen, and an angle of view of the image acquiring module, calculates the distance by using the received number of pixels of the test chart, the received resolution of the display screen, the received angle of view of the image acquiring module, and a ratio between a size of the test chart contained in the acquired image and a size of the acquired image, and transmits the distance to the display device as the adjustment information.

### First Embodiment

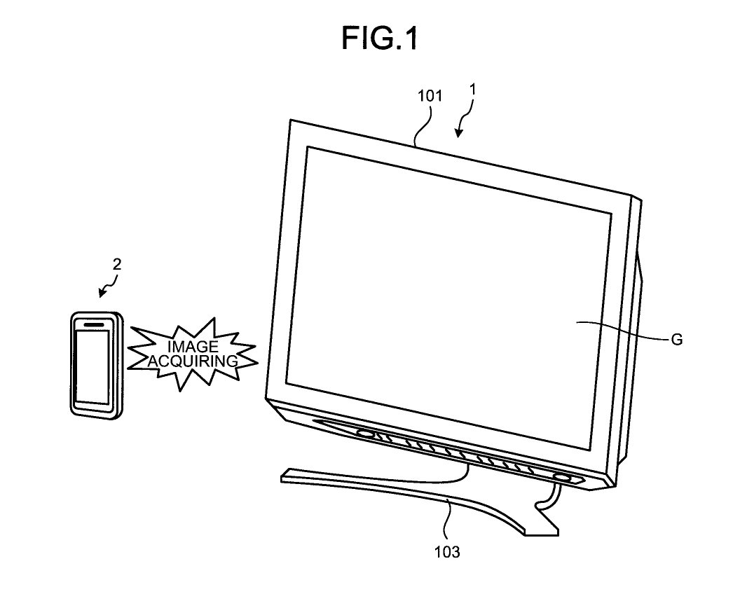

FIG. 1 is an external perspective view illustrating an example of a television broadcast display device according to a first embodiment. As illustrated in FIG. 1, this television broadcast display device 1 is configured by a liquid crystal display (LCD), for example, and comprises a housing 101 supported by a supporting portion 103 and having a rectangle shape when the housing 101 is seen from the front, and a display screen G that is capable of displaying various types of information such as static images and moving images. The television broadcast display device 1 according to the first embodiment is an example of a display device comprising the display screen G.

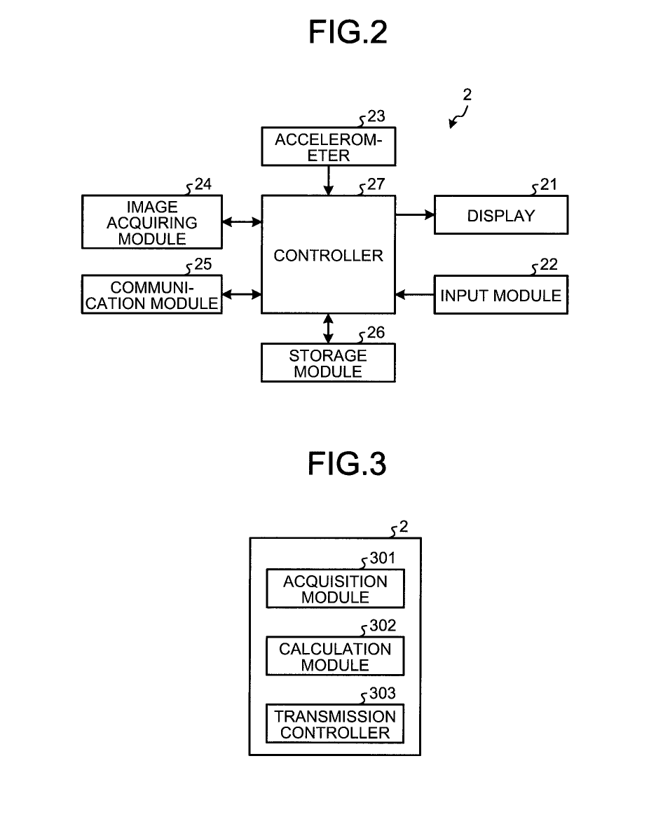

FIG. 2 is a diagram illustrating an example of a hardware configuration of a mobile terminal device in the first embodiment. As illustrated in FIGS. 1 and 2, this mobile terminal device 2 in the first embodiment comprises a display 21, an input module 22, an accelerometer 23, an image acquiring module 24, a communication module 25, a storage module 26, and a controller 27. The mobile terminal device 2 also comprises other components such as a speaker and a microphone (not illustrated).

The display 21 is a display device constituted by an LCD or an organic electro luminescence (EL) display, for example, and capable of displaying an acquired image acquired by the image acquiring module 24. The display 21 displays various types of information under the control of the controller 27.

The input module 22 is configured by a pointing device or buttons, for example, and receives various types of instructions and information from a user. Although the input module 22 in the first embodiment employs a touch panel comprising a transparent coordinate detection device disposed on a screen of the display 21 as a pointing device, the embodiment is not limited to this.

The accelerometer 23 is a sensing device that senses acceleration of the mobile terminal device 2. For example, the accelerometer 23 outputs a change (tilt or rotation) in the position of the mobile terminal device 2 in three directions as a sensing result.

The image acquiring module 24 is capable of acquiring at least a part of the display screen G of the television broadcast display device 1 from the front of the display screen G.

The communication module 25 is a communication interface that is connectable to a network (not illustrated) such as the Internet. The communication module 25 transmits and receives various types of information to and from an external device (such as the television broadcast display device 1) connected to the network, under the control of the controller 27.

The storage module 26 comprises non-volatile storage media such as a read-only memory (ROM), a hard disk drive (HDD), and a solid state drive (SDD), and stores therein various types of programs and information such as setting information.

The controller 27 comprises a central processing unit (CPU) and a random access memory (RAM) (neither of them is illustrated), and controls the overall operation of the mobile terminal device 2 in cooperation with the computer programs stored in the storage module 26.

Next, described is a functional configuration of the mobile terminal device 2 according to the first embodiment with reference to FIG. 3. FIG. 3 is a block diagram illustrating a functional configuration of the mobile terminal device in the first embodiment.

As illustrated in FIG. 3, the mobile terminal device 2 implements an acquisition module 301, a calculation module 302, and a transmission controller 303 by executing a program (display control application) stored in the storage module 26 by the CPU and other modules comprised in the controller 27.

The acquisition module 301 acquires information necessary for acquiring a distance (hereinafter referred to as “viewing distance”) from the display screen G of the television broadcast display device 1 to the mobile terminal device 2, such as angle-of-view information indicating an angle of view of the image acquiring module 24, and size information indicating a size (the length of a side of the display screen G) of the display screen G of the television broadcast display device 1 that are input through the input module 22.

When an acquired image acquired by the image acquiring module 24 contains a calculation image (such as a side of the display screen G of the television broadcast display device 1) that is an image required for calculating the viewing distance, the calculation module 302 calculates the viewing distance by using an angle of view indicated by the angle-of-view information and the size of the display screen G indicated by the size information that are acquired by the acquisition module 301 (in other words, that are input from the input module 22), and a ratio between the length of a side of the display screen G contained in the acquired image and the length of a side of the acquired image.

The transmission controller 303 transmits adjustment information (such as the viewing distance calculated by the calculation module 302 in the first embodiment) for causing the television broadcast display device 1 to adjust image quality of the display screen G thereof to the television broadcast display device 1 via the communication module 25. In other words, the acquisition module 301, the calculation module 302, and the transmission controller 303 in the first embodiment serve as a transmitter that transmits, to the television broadcast display device 1, adjustment information for causing the television broadcast display device 1 to adjust image quality of the display screen G on the basis of the viewing distance, when the acquired image acquired by the image acquiring module 24 contains a calculation image.

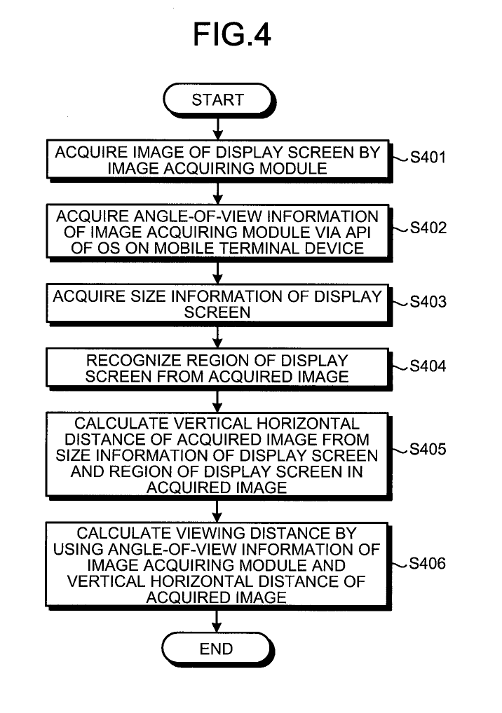

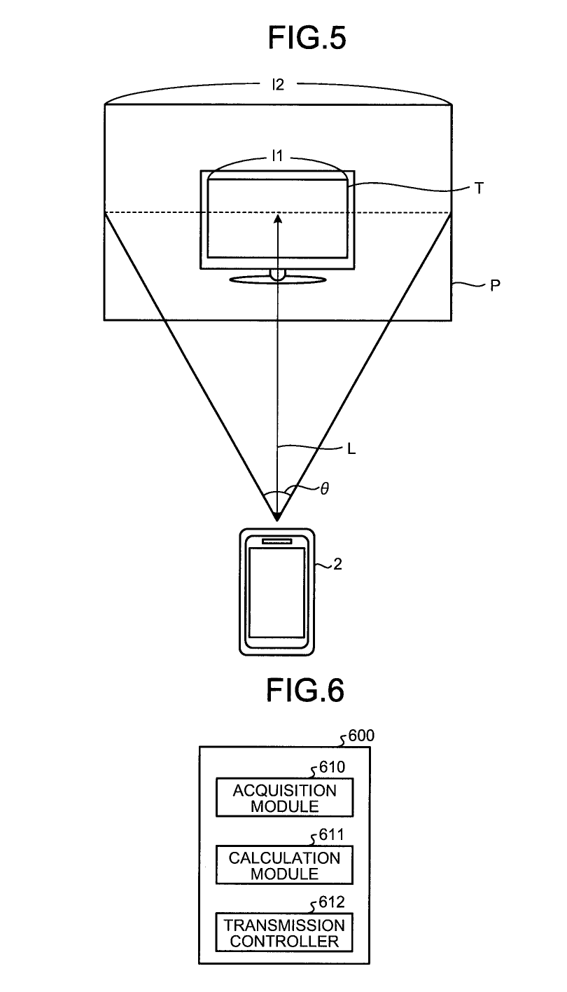

Next, described in detail is a processing for calculating the viewing distance by the mobile terminal device 2 according to the first embodiment with reference to FIGS. 3 to 5. FIG. 4 is a flowchart illustrating a processing for calculating the viewing distance by the mobile terminal device in the first embodiment. FIG. 5 is a diagram for explaining a processing for calculating the viewing distance by the mobile terminal device in the first embodiment.

When a display control application starts up that causes the television broadcast display device 1 to adjust image quality of the display screen G thereof, the image acquiring module 24 acquires an image of the display screen G of the television broadcast display device 1 (S401). In the first embodiment, the image acquiring module 24 acquires an image of the display screen G of the television broadcast display device 1 in such a manner in which the acquired image contains the image of the entire television broadcast display device 1. The image acquiring module 24 may acquire an image of the display screen G of the television broadcast display device 1 in such a manner in which the acquired image contains at least a portion of the display screen G.

When the image acquiring module 24 starts acquiring an image of the display screen G, the display 21 displays an acquired image acquired by the image acquiring module 24. This enables the user of the mobile terminal device 2 to check whether the acquired image acquired by the image acquiring module 24 contains a calculation image required for calculating the viewing distance from the display screen G to the mobile terminal device 2 by looking at the acquired image displayed on the display 21. Thus, the user can adjust an image acquiring region of the image acquiring module 24 such that the acquired image acquired by the image acquiring module 24 contains the calculation image.

The acquisition module 301 acquires angle-of-view information indicating an angle of view of the image acquiring module 24 via an application program interface (API) of an operating system (OS) on the mobile terminal device 2 (S402). When the OS on the mobile terminal device 2 is Android (registered trademark), for example, the acquisition module 301 transmits a “public float getHorizontalViewAngle” command that is an Android API command to an API of Android (registered trademark) that is the OS on the mobile terminal device 2, so that the acquisition module 301 acquires the angle-of-view information indicating the angle of view of the image acquiring module 24.

Although the acquisition module 301 in the first embodiment acquires angle-of-view information via an API of the OS on the mobile terminal device 2, the embodiment is not limited to this. The acquisition module 301 may acquire angle-of-view information indicating an angle of view of the image acquiring module 24 from, for example, an Exif file contained in acquired image data of a acquired image acquired by the image acquiring module 24. The acquisition module 301 may also acquire (calculate) an angle of view of the image acquiring module 24 on the basis of information (such as the focal length for 35 mm photography equivalent) that is acquired from the Exif file and that is capable of specifying the angle of view of the image acquiring module 24.

The acquisition module 301 acquires size information indicating the size of the display screen G of the television broadcast display device 1 (S403). In the first embodiment, the acquisition module 301 acquires specifying information (such as model number information of the television broadcast display device 1) that is input by the user through the input module 22 and that is capable of specifying the size of the display screen G. The acquisition module 301 then acquires the size information indicating the size (vertical height and horizontal length [mm] of the display screen G) of the display screen G by using the specifying information thus acquired.

The calculation module 302 recognizes the display screen G (an image of the display screen G) of the television broadcast display device 1 from the acquired image acquired by the image acquiring module 24 (S404). In the first embodiment, the calculation module 302 uses the outline of the entire television broadcast display device 1 contained in an acquired image acquired by the image acquiring module 24 to recognize (detect) an image of the display screen G in the acquired image. When recognizing the image of the display screen G from the acquired image, the calculation module 302 determines whether a calculation image (in the first embodiment, the image of the entire display screen G) is contained in the acquired image by using the outline of the entire television broadcast display device 1 in the acquired image. Although, in the first embodiment, the calculation module 302 determines whether the acquired image contains the image of the entire display screen G, the calculation module 302 may determine whether the acquired image contains an image (an example of the calculation image), such as an image of a side of the display screen G, that is capable of specifying at least the length of the display screen G in the vertical direction (up-down direction) or in the horizontal direction (right-left direction).

When the calculation module 302 determines that the acquired image contains a calculation image, the calculation module 302 calculates a vertical horizontal distance of the acquired image by using the size of the display screen G indicated by the size information acquired by the acquisition module 301, and a region (such as the length of at least one of the images of the right, left, upper and lower side of the display screen G in the acquired image) of an image of the display screen G in the acquired image acquired by the image acquiring module 24 (S405). The vertical horizontal distance of the acquired image is the length of an acquired region that is a region acquired by the image acquiring module 24 in the vertical direction (up-down direction) or in the horizontal direction (right-left direction). In the first embodiment, the calculation module 302 uses the outline of the entire television broadcast display device 1 contained in the acquired image to detect the region (the right, left, upper and lower sides of the display screen G in the acquired image) of an image of the display screen in the acquired image.

In a case in which the calculation module 302 calculates the horizontal length of an acquired region as the vertical horizontal distance of the acquired image, the calculation module 302 calculates the ratio between an upper length 11 of an image T of the display screen G in an acquired image P acquired by the image acquiring module 24 and an upper length 12 of the acquired image P as illustrated in FIG. 5. The calculation module 302 then calculates the horizontal length of the acquired region on the basis of the calculated ratio and the horizontal length of the display screen G indicated by the acquired size information. The calculation module 302 also calculates the vertical height of the acquired region in the same manner.

The calculation module 302 is capable of determining which to calculate between the vertical height and the horizontal length of the acquired region as the vertical horizontal distance of the acquired image depending on the calculation image contained in the acquired image. For example, when the acquired image contains a calculation image (an image of the left or right side of the display screen G) that is capable of specifying the vertical height of the display screen G, the calculation module 302 calculates the vertical height of the acquired region as the vertical horizontal distance of the acquired image. When the acquired image contains a calculation image (an image of the upper or lower side of the display screen G) that can specify the horizontal length of the display screen G, the calculation module 302 calculates the horizontal length of the acquired region as the vertical horizontal distance of the acquired image. When the acquired image contains a calculation image that is an image of the entire display screen G, the calculation module 302 calculates the vertical height or the horizontal length of the acquired region as the vertical horizontal distance of the acquired image according to a predetermined setting.

The calculation module 302 calculates the viewing distance from the display screen G of the television broadcast display device 1 to the mobile terminal device 2 by using the angle of view indicated by the angle-of-view information acquired by the acquisition module 301, and the vertical horizontal distance of the acquired image (S406). In other words, the calculation module 302 calculates the viewing distance by using the size of the display screen G indicated by the acquired size information, the angle of view indicated by the acquired angle-of-view information, and the ratio between the length of a side of the display screen G in the acquired image acquired by the image acquiring module 24 and the length of a side of the acquired image.

In the first embodiment, the calculation module 302 calculates a viewing distance L on the basis of an angle of view θ indicated by the acquired angle-of-view information, and the vertical horizontal distance (the horizontal length of the acquired region) of the acquired image as illustrated in FIG. 5. Specifically, the calculation module 302 calculates the viewing distance L on the basis of Formula (1) below.

Viewing distance L=vertical horizontal distance of an acquired image/2tan(θ/2) (1)

Although a case is described in which the calculation module 302 calculates the viewing distance L by using the horizontal length of the acquired region as the vertical horizontal distance of the acquired image, the calculation module 302 also calculates the viewing distance L by using the vertical height of the acquired region as the vertical horizontal distance of the acquired image in the same manner as in the case described above.

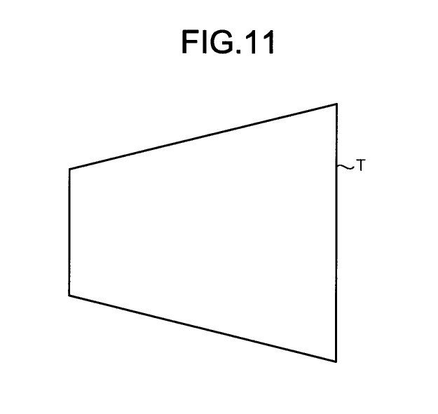

When the right side and the left side of an image of the display screen G contained in the acquired image are different in length (see FIG. 11) because the position of a user tilts in the right direction or in the left direction relative to the front of the display screen G, the calculation module 302 may determine an average value of a viewing distance calculated by using the right side of the image of the display screen G contained in the acquired image and a viewing distance calculated by using the left side thereof as the viewing distance. In other words, the calculation module 302 calculates the viewing distance by using an intermediate value of lengths of the right side and the left side of the display screen G contained in the acquired image.

After the calculation module 302 calculates the viewing distance, the transmission controller 303 transmits the calculated viewing distance to the television broadcast display device 1 as adjustment information for causing the television broadcast display device 1 to adjust the image quality of the display screen G thereof.

Although, in the first embodiment, the transmission controller 303 transmits the viewing distance as adjustment information to the television broadcast display device 1, the embodiment is not limited to this. The adjustment information may be any form of information for causing the television broadcast display device 1 to adjust image quality of the display screen G on the basis the viewing distance calculated from the acquired image. For example, the transmission controller 303 may transmit acquired image data of an acquired image (acquired image containing a calculation image) acquired by the image acquiring module 24 to the television broadcast display device 1 (or a server not illustrated) as the adjustment information. In this case, the television broadcast display device 1 (or the server not illustrated) calculates the viewing distance by performing the same processing as that at S402 to S406 described above. The transmission controller 303 may also transmit a parameter (such as resolution used when the television broadcast display device 1 enhances the resolution of an image displayed on the display screen G) used for adjusting image quality of the display screen G on the basis of the calculated viewing distance, to the television broadcast display device 1 as the adjustment information.

As described above, the mobile terminal device 2 according to the first embodiment uses an acquired image acquired by the image acquiring module 24 of the mobile terminal device 2 to cause the television broadcast display device 1 to adjust image quality on the basis of a viewing distance calculated from the acquired image. This enables the television broadcast display device 1 to receive the viewing distance and to adjust image quality of the display screen G on the basis of the received viewing distance without providing a distance sensor or a camera for the television broadcast display device 1 that increases cost of a television set comprising the housing of the television broadcast display device 1 and a remote control, and that limits the flexibility of design for the housing of the television broadcast display device 1. The user of the mobile terminal device 2 looks at a acquired image displayed on the display 21, so that the user can check whether the acquired image acquired by the image acquiring module 24 contains a calculation image required for calculating the viewing distance from the display screen G to the mobile terminal device 2. This allows the user to adjust an acquired region of the image acquiring module 24 so that the acquired image acquired by the image acquiring module 24 contains the calculation image.

Although, in the first embodiment, the calculation module 302 calculates the viewing distance by using an angle of view of the image acquiring module 24 indicated by the angle-of-view information acquired by the acquisition module 301, the calculation module 302 is also capable of calculating the viewing distance without using the angle of view of the image acquiring module 24 when the image acquiring module 24 acquires an image used for the calculation of the viewing distance at a predetermined angle of view. In this case, the mobile terminal device 2 stores, in the storage module 26, a size (the length of a side of the display screen G) of the display screen G, the number of pixels of a side of the image T on the display screen G contained in the acquired image acquired by the image acquiring module 24 at the predetermined angle of view, and the viewing distance in a manner associated with one another.

When the display control application starts up, the image acquiring module 24 acquires at least a portion of the display screen G at a predetermined angle of view. The calculation module 302 then reads out, from the storage module 26, a viewing distance stored in association with the length of a side of the display screen G acquired by the acquisition module 301 and the number of pixels of a side of the display screen G contained in the acquired image acquired by the image acquiring module 24. The transmission controller 303 transmits the viewing distance thus read out to the television broadcast display device 1 as adjustment information.

### Second Embodiment

The following describes a second embodiment in which the viewing distance is calculated by using a test chart displayed on the display screen of the television broadcast display device. The following description omits the same parts as those described in the first embodiment.

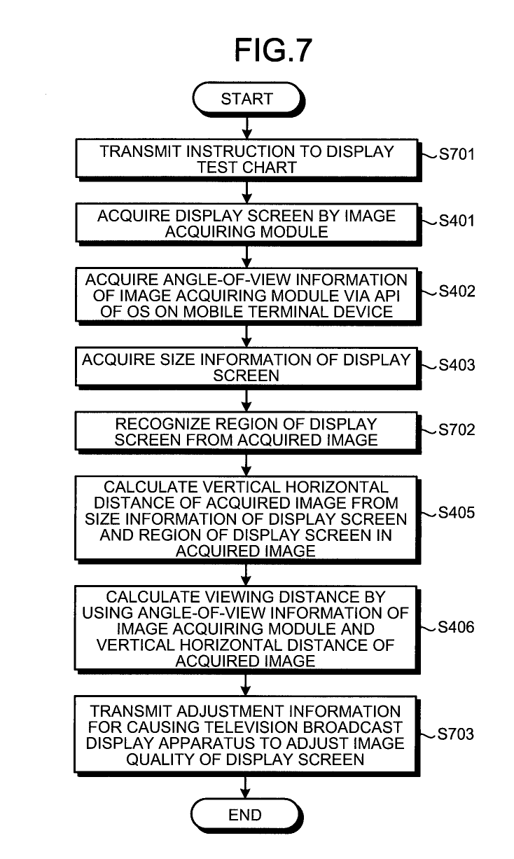

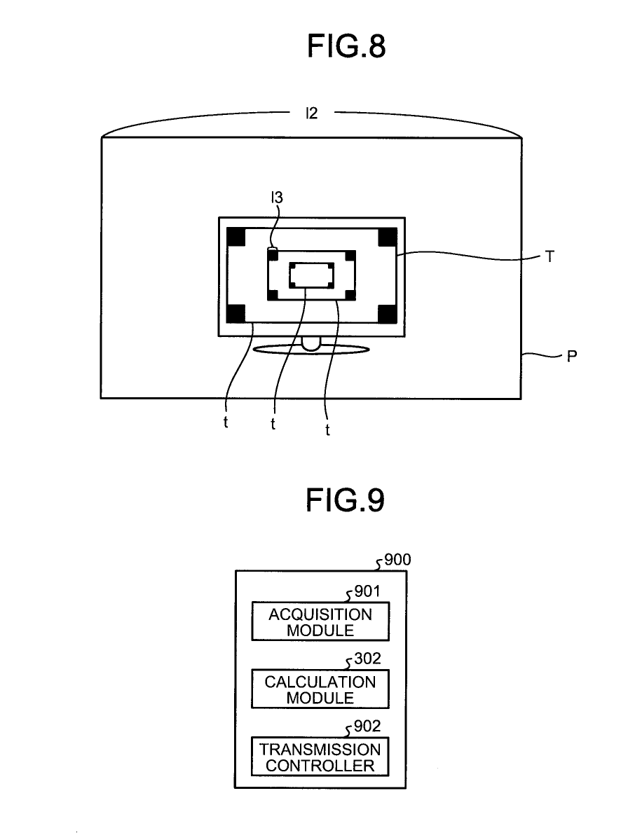

The following describes in detail the processing for transmitting adjustment information performed by a mobile terminal device 600 according to the second embodiment with reference to FIGS. 6 to 8. FIG. 6 is a block diagram illustrating a functional configuration of the mobile terminal device according to the second embodiment. FIG. 7 is a flowchart illustrating a processing for transmitting adjustment information by the mobile terminal device in the second embodiment. FIG. 8 is a diagram illustrating an example of an acquired image obtained by acquiring a display screen displaying a test chart.

In the second embodiment, when the display control application starts up, a transmission controller 612 transmits an instruction to display a predetermined test chart (a test chart for recognizing the display screen) to the television broadcast display device 1 before the image acquiring module 24 acquires an image (S701). The television broadcast display device 1 displays the predetermined test chart on the display screen G on receiving the instruction to display the test chart from the mobile terminal device 600.

In the second embodiment, a calculation module 611 recognizes an image of the display screen G of the television broadcast display device 1 by using an image of the test chart contained in the acquired image acquired by the image acquiring module 24 (S702). This enables the calculation module 611 to easily recognize an image of the display screen G from the acquired image acquired by the image acquiring module 24. Specifically, as illustrated in FIG. 8, the calculation module 611 recognizes, as the image T of the display screen G, a region inside the outermost test chart image t among a plurality of test chart images t each having a rectangle shape contained in the acquired image P acquired by the image acquiring module 24.

As illustrated in FIG. 8, when the acquired image P acquired by the image acquiring module 24 contains a test chart image t, the mobile terminal device 600 is capable of calculating the viewing distance by using the test chart image t. First, an acquisition module 610 acquires the number of pixels (such as the number of pixels of a square region disposed at each of the four corners of the rectangle test chart, or the number of pixels of a side of the rectangle test chart) of a test chart displayed on the display screen G, the resolution of the display screen G, and angle-of-view information indicating an angle of view of the image acquiring module 24. In the second embodiment, the acquisition module 610 acquires the number of pixels of a test chart, the resolution of the display screen G, and angle-of-view information indicating an angle of view of the image acquiring module 24 that are input through the input module 22.

Next, the calculation module 611 calculates the viewing distance by using the number of pixels of the test chart, the resolution of the display screen G, and the angle of view indicated by the angle-of-view information that are acquired by the acquisition module 610, and a ratio between the length of a side of the test chart contained in the acquired image acquired by the image acquiring module 24 and the length of a side of the acquired image. Specifically, the calculation module 611 uses the acquired number of pixels of the test chart and the acquired resolution of the display screen to calculate the length of a side of the test chart displayed on the display screen G (such as the length of a side of a square region disposed at each of the four corners of the rectangle test chart, or the length of a side of the rectangle test chart).

The calculation module 611 calculates the vertical horizontal distance of the acquired image from the size of the test chart calculated, and the ratio between the length of a side of the test chart contained in the acquired image acquired by the image acquiring module 24 and the length of a side of the acquired image. As illustrated in FIG. 8, for example, the calculation module 611 calculates a ratio of the upper length 12 of the acquired image P to the size (such as a length 13 of a side of a square image disposed at each of the four corners of the rectangle test chart) of the test chart image t contained in the acquired image P acquired by the image acquiring module 24. The calculation module 611 then calculates the horizontal length of the acquired region on the basis of the calculated ratio and the acquired size of the test chart (such as the length of a side of a square region disposed at each of the four corners of the rectangle test chart). The calculation module 611 calculates the viewing distance by using the angle of view indicated by the angle-of-view information and the calculated vertical horizontal distance of the acquired image. The transmission controller 612 transmits the calculated viewing distance to the television broadcast display device 1 as adjustment information for causing the television broadcast display device 1 to adjust image quality of the display screen G thereof (S703).

The mobile terminal device 600 according to the second embodiment is capable of calculating the viewing distance by using the number of pixels of a test chart, the resolution of the display screen G, an angle of view indicated by the angle-of-view information, and a ratio between the length of a side of the test chart contained in the acquired image acquired by the image acquiring module 24 and the length of a side of the acquired image, as long as the acquired image contains the test chart. This enables the mobile terminal device 600 to calculate the viewing distance even when the angle of view of the image acquiring module 24 is too small to acquire an image containing a calculation image that can specify the vertical height or the horizontal length of the display screen G.

### Third Embodiment

The following describes a third embodiment in which the mobile terminal device receives, from the television broadcast display device, specifying information that is capable of specifying the size of the display screen of the television broadcast display device, and uses the received specifying information to acquire the size of the display screen. The following description omits the same parts as those described in the second embodiment.

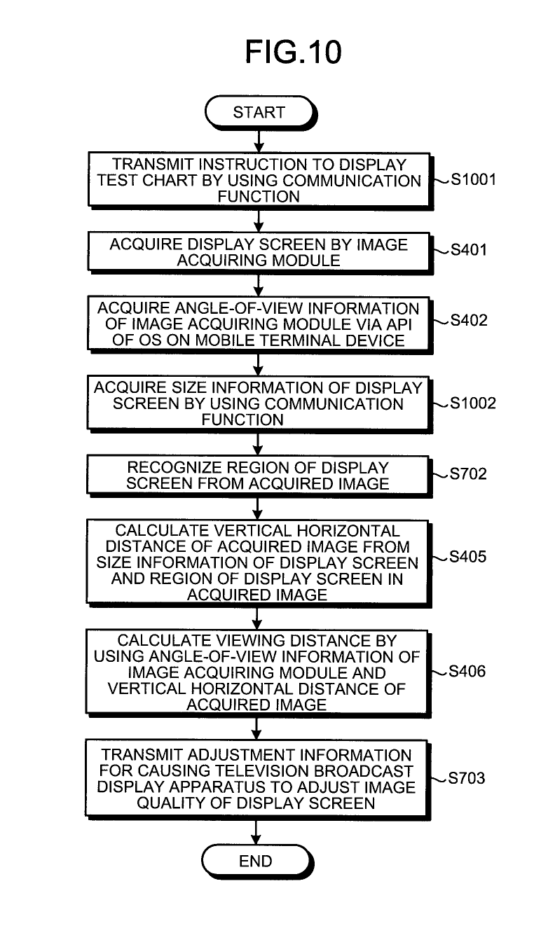

The following describes the processing for transmitting adjustment information by a mobile terminal device 900 according to the third embodiment with reference to FIGS. 9 and 10. FIG. 9 is a block diagram illustrating a functional configuration of the mobile terminal device according to the third embodiment. FIG. 10 is a flowchart illustrating a processing for transmitting adjustment information by the mobile terminal device according to the third embodiment.

In the third embodiment, a transmission controller 902 transmits an instruction to display a predetermined test chart to the television broadcast display device 1 by using a communication function such as a function of application software (hereinafter referred to as APPS function), or a universal serial bus (USB) (S1001).

In the third embodiment, an acquisition module 901 receives, from the television broadcast display device 1, specifying information (such as model number information of the television broadcast display device 1) that is capable of specifying the size of the display screen G of the television broadcast display device 1 by using the communication function such as the APPS function or the USB. The acquisition module 901 acquires size information indicating the size of the display screen G by using the specifying information thus received (S1002).

The mobile terminal device 900 according to the third embodiment receives specifying information from the television broadcast display device 1 by using the communication function and uses the received specifying information to acquire the size of the display screen G, thereby automatically acquiring the size of the display screen G. The viewing distance is calculated when the user of the mobile terminal device 900 simply acquires an image of the display screen G with the image acquiring module 24, whereby the user can use the mobile terminal device 900 more conveniently.

### MODIFICATION

The present modification describes an example in which the mobile terminal device acquires a viewing position that is at least the position of a user (viewer) in the horizontal direction (right-left direction) or in the vertical direction (up-down direction) relative to the front of the display screen, depending on the shape of an image of the display screen contained in the acquired image acquired by the image acquiring portion. The following description omits the same parts as those described in the above embodiments.

In the present modification, the calculation module 302 calculates a ratio (hereinafter referred to as a first ratio) between a vertical height and a horizontal length of the display screen G indicated by the size information acquired by the acquisition module 301. When an image of the display screen G is recognized from the acquired image, the calculation module 302 calculates a ratio (hereinafter referred to as a second ratio) between a vertical height and a horizontal length of the image of the display screen G. The calculation module 302 then acquires a viewing position that is the position of a viewer in the right-left direction and in the up-down direction relative to the front of the display screen G on the basis of the first ratio and the second ratio.

The calculation module 302 may acquire a viewing position that is the position of a viewer in the right-left direction relative to the front of the display screen G on the basis of respective lengths of the right side and the left side of the image of the display screen G recognized from the acquired image. The calculation module 302 may acquire a viewing position that is the position of a viewer in the up-down direction relative to the front of the display screen G on the basis of respective lengths of the upper side and the lower side of the image of the display screen G recognized from the acquired image.

FIG. 11 is a diagram for explaining the processing for acquiring a viewing position by the mobile terminal device according to the modification. As illustrated in FIG. 11, for example, when the length of the right side of the image T of the display screen G is larger than the length of the left side of the image T of the display screen G recognized from the acquired image, the calculation module 302 determines that the position of a viewer is in the right direction relative to the front of the display screen G with respect to the right-left direction.

When the display screen G of the television broadcast display device 1 displays a test chart, the calculation module 611 is capable of acquiring a viewing position of a user in the right-left direction and the up-down direction relative to the front of the display screen G according to the shape of an image of the test chart contained in the acquired image acquired by the image acquiring module 24. Specifically, as illustrated in FIG. 8, the calculation module 611 acquires the viewing position of a user in the right-left direction and in the up-down direction relative to the front of the display screen G according to the size of square images disposed at the four corners of the rectangle test chart image t contained in the acquired image P. For example, when the square image at the upper left corner is the largest in size among the square images disposed at the four corners of the test chart image t, the calculation module 611 determines that the viewing position of the user is in the upper left relative to the front of the display screen G.

According to the first to the third embodiments described above, the television broadcast display device 1 is capable of acquiring a viewing distance, and adjusting image quality of the display screen G on the basis of the acquired viewing distance without providing a distance sensor or a camera to the television broadcast display device 1 that increases cost of a television set comprising a housing of the television broadcast display device 1 and a remote control, and that limits the flexibility of design for the housing of the television broadcast display device 1.

The program executed by the mobile terminal devices 2, 600, and 900 according to the embodiments above maybe recorded and provided in a computer-readable recording medium such as a compact disc read-only memory (CD-ROM), a flexible disk (FD), a compact disc recordable (CD-R), and a digital versatile disc (DVD), as an installable or executable file.

The program executed by the mobile terminal devices 2, 600, and 900 according to the embodiments above may be stored in a computer connected to a network such as the Internet and provided by being downloaded via the network. Furthermore, the program executed by the mobile terminal devices 2, 600, and 900 according to the embodiments above may be provided or distributed via a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile terminal device comprising:
an image acquiring module that is capable of acquiring an image of at least a portion of a display screen of a display device;
a display that is capable of displaying an acquired image acquired by the image acquiring module;
a receiver that receives, from the display device, specifying information that is capable of specifying a size of the display screen; and
a transmitter, wherein,
when the acquired image contains a side of the display screen, the transmitter calculates a distance from the display screen to the mobile terminal device by using the size of the display screen specified by the received specifying information, an angle of view of the image acquiring module, and a ratio between a length of a side of the display screen contained in the acquired image and a length of a side of the acquired image, and transmits the distance to the display device as an adjustment information for causing the display device to adjust image quality of the display screen, and,
when the acquired image contains a test chart displayed on the display screen, the transmitter receives a number of pixels of the test chart, resolution of the display screen, and an angle of view of the image acquiring module, calculates the distance by using the received number of pixels of the test chart, the received resolution of the display screen, the received angle of view of the image acquiring module, and a ratio between a size of the test chart contained in the acquired image and a size of the acquired image, and transmits the distance to the display device as the adjustment information.

2. The mobile terminal device of claim 1, further comprising:
a storage module that stores therein a length of a side of the display screen, a number of pixels of a side of the display screen contained in the acquired image acquired by the image acquiring module at a certain angle of view, and the distance, in association with each other, wherein
the image acquiring module is capable of acquiring at least a portion of the display screen at the certain angle of view, and
the transmitter receives the length of the side of the display screen, and transmits the distance stored in association with the received length of the side of the display screen and the received number of pixels of the side of the display screen contained in the acquired image, as the adjustment information.

3. The mobile terminal device of claim 1, wherein the transmitter transmits an instruction to display the test chart to the display device before the image acquiring module acquires an image.

4. The mobile terminal device of claim 1, wherein the transmitter acquires the angle of view of the image acquiring module via an application program interface (API) of an operating system (OS) installed in the mobile terminal device.

5. A display control method performed in a mobile terminal device comprising an image acquiring module and a display, the image acquiring module being capable of acquiring an image of at least a portion of a display screen of a display device, and the display being capable of displaying an acquired image acquired by the image acquiring module, the display control method comprising:
receiving, by a receiver from the display device, specifying information that is capable of specifying a size of the display screen;
calculating, by a transmitter and when the acquired image contains a side of the display screen, a distance from the display screen to the mobile terminal device by using the size of the display screen specified by the received specifying information, an angle of view of the image acquiring module, and a ratio between a length of a side of the display screen contained in the acquired image and a length of a side of the acquired image, and transmitting the distance to the display device as an adjustment information for causing the display device to adjust image quality of the display screen; and
receiving, by the transmitter and when the acquired image contains a test chart displayed on the display screen, a number of pixels of the test chart, resolution of the display screen, and an angle of view of the image acquiring module, calculates the distance by using the received number of pixels of the test chart, the received resolution of the display screen, the received angle of view of the image acquiring module, and a ratio between a size of the test chart contained in the acquired image and a size of the acquired image, and transmits the distance to the display device as the adjustment information.

6. A computer program product having a non-transitory computer readable medium including programmed instructions, wherein the instructions, when executed by a computer that controls a mobile terminal device comprising an image acquiring module and a display, the image acquiring module being capable of acquiring an image of at least a portion of a display screen of a display device, the display being capable of displaying an acquired image acquired by the image acquiring module, cause the computer to perform:
receiving, by a receiver from the display device, specifying information that is capable of specifying a size of the display screen;
calculating, by a transmitter and when the acquired image contains a side of the display screen, a distance from the display screen to the mobile terminal device by using the size of the display screen specified by the received specifying information, an angle of view of the image acquiring module, and a ratio between a length of a side of the display screen contained in the acquired image and a length of a side of the acquired image, and transmitting the distance to the display device as an adjustment information for causing the display device to adjust image quality of the display screen; and
receiving, by the transmitter and when the acquired image contains a test chart displayed on the display screen, a number of pixels of the test chart, resolution of the display screen, and an angle of view of the image acquiring module, calculates the distance by using the received number of pixels of the test chart, the received resolution of the display screen, the received angle of view of the image acquiring module, and a ratio between a size of the test chart contained in the acquired image and a size of the acquired image, and transmits the distance to the display device as the adjustment information.
